(19) United States
(12) Patent Application Publication
(10) Pub. No.: US 2026/0295633 A1
(43) Pub. Date: Oct. 1, 2026

(54) DECORATIVE FILM

(71) Applicant: KCC GLASS CORPORATION, Seoul (KR)

(72) Inventors: Jeong Hee LEE, Seoul (KR); Jin Woo PARK, Asan-si, Chungcheongnam-do (KR); Byung Young JUNG, Yongin-si, Gyeonggi-do (KR); Jang Wook KIM, Yongin-si, Gyeonggi-do (KR); Sung Ha SEO, Gunpo-si, Gyeonggi-do (KR); Young Hwan MOON, Sejong (KR)

(21) Appl. No.: 19/481,179

(22) PCT Filed: Mar. 27, 2024
(86) PCT No.: PCT/KR2024/003844

§ 371 Date: Nov. 4, 2025

(30) Foreign Application Priority Data
Jun. 2, 2023 (KR) 10-2023-0071656

(51) Int. Cl. B05D 7/00; C09D 5/00; C09D 11/101; C09D 167/00; C09D 175/04

(52) U.S. Cl. CPC B05D 7/57; C09D 5/002; C09D 11/101; C09D 167/00; C09D 175/04; B05D 2201/02; B05D 2401/10; B05D 2401/31; B05D 2502/00; B05D 2503/00; B05D 2506/25; B05D 2508/00

(57) ABSTRACT

The present invention relates to a decorative film using digital UV ink and having a high degree of design freedom and excellent moldability. The decorative film of the present invention can be applied as an interior film, a film for home appliances, a decorative film, a laminating film, a vinyl-coated metal (VCM), a luxury vinyl tile (LVT), flooring (a floor sheet), and the like.

### TECHNICAL FIELD

The present invention relates to a decorative film that has a high degree of design freedom and excellent formability.

### BACKGROUND ART

Decorative films, such as interior films, have conventionally been manufactured by forming a print layer on sheets of PET, PVC, and the like using printing methods such as offset printing, gravure printing, and flexo printing, and various technologies for manufacturing decorative films by these methods have been proposed. For example, Korean Patent Publication No. 2021-0077834 discloses an interior film including an adhesive layer containing an acrylic copolymer, water, a tackifier, and an additive; a substrate layer containing a heat stabilizer and a PVC resin; and a print layer containing a solvent with a boiling point of 120° C. or lower, and a method for manufacturing the same.

According to the conventional methods, it is necessary to manufacture a copper plate (printing roll) to implement a design on a product, but copper plate production is costly and time-consuming. Moreover, these methods have limitations in vividly expressing images and face issues in that process changeovers are time-consuming and there is an increased risk of safety-related incidents. In addition, producing copper plates for design changes requires additional cost and time. Since inks containing organic solvents are used, volatile organic compounds (VOCs) are released into the atmosphere during the ink drying process, which deteriorates the working environment and causes environmental problems.

To address these issues, methods using digital printers have been attempted. However, conventional ink compositions have insufficient compatibility with film substrates, inadequate print resolution, and low peel strength, resulting in problems such as cracking or film peeling upon application, which leads to poor formability. Accordingly, there is a demand for developing decorative films with a high degree of design freedom and excellent formability.

### DISCLOSURE

### Technical Problem

The present invention provides a decorative film that has a high degree of design freedom and excellent formability.

### Technical Solution

The present invention provides a decorative film including a substrate layer, a print layer formed by digital printing, a first primer layer, and a transparent layer, which are sequentially laminated, wherein the print layer is formed of a UV ink composition, the peel strength between the substrate layer and the print layer is 3.0 kgf/inch or more, and the peel strength between the print layer and the transparent layer is 3.0 kgf/inch or more.

### Advantageous Effects

The present invention provides a decorative film that has a high degree of design freedom and excellent formability. According to the present invention, since there is no need to manufacture a copper plate, production costs and time are reduced, thereby accelerating product development. Since inks containing organic solvents are not used, products can be manufactured by an environmentally friendly method. The decorative film of the present invention is suitable for various applications, including interior films, films for home appliances, decorative films, lamination films, vinyl coated metals (VCMs), luxury vinyl tiles (LVTs), and flooring materials (floor sheets).

### BEST MODE

Hereinafter, the present invention will be described in detail. However, the following description is not intended to limit the present invention, and each component may be variously modified or optionally combined as needed. Therefore, it should be understood to include all modifications, equivalents, and substitutes encompassed by the spirit and scope of the present invention.

As used herein, “weight average molecular weight” is measured by conventional methods known in the art, for example, by gel permeation chromatography (GPC). “Glass transition temperature” is measured by conventional methods known in the art, for example, by differential scanning calorimetry (DSC). “Particle size (D50)” is measured by conventional methods known in the art, for example, by laser light scattering (LLS).

The decorative film of the present invention includes a substrate layer, a print layer formed by digital printing, a first primer layer, and a transparent layer, which are sequentially laminated, wherein the print layer is formed of a UV ink composition, the peel strength between the substrate layer and the print layer is 3.0 kgf/inch or more, and the peel strength between the print layer and the transparent layer is 3.0 kgf/inch or more. Accordingly, the decorative film of the present invention may be applied to products requiring high formability because cracking or film delamination does not occur when applied to products.

The peel strength refers to the force at which interlayer delamination occurs or a part of a specific layer is peeled off during the separation of some layers in a laminated structure.

The peel strength between the print layer and the transparent layer refers to the force at which peeling or partial separation occurs during the process of peeling the transparent layer from the print layer. When the substrate layer, the print layer, the first primer layer, and the transparent layer are sequentially laminated, peeling between the print layer and the transparent layer may occur between the print layer and the first primer layer and/or between the first primer layer and the transparent layer. For example, peeling may occur between the print layer and the first primer layer.

The peel strength between the substrate layer and the print layer refers to the force at which peeling or partial separation occurs during the process of peeling the print layer from the substrate layer. When the substrate layer, a second primer layer, the print layer, the first primer layer, and the transparent layer are sequentially laminated, peeling between the substrate layer and the print layer may occur between the substrate layer and the second primer layer and/or between the second primer layer and the print layer. For example, peeling may occur between the second primer layer and the print layer.

For example, the peel strength may be measured using a universal testing machine (UTM) by the 180° peeling method.

The peel strength between the substrate layer and the print layer may be 3.0 kgf/inch or more, for example, 3.0 to 10 kgf/inch, 3.5 to 8.0 kgf/inch, or 5.0 to 6.0 kgf/inch. The peel strength between the print layer and the transparent layer may be 3.0 kgf/inch or more, for example, 3.0 to 10 kgf/inch, 3.5 to 8.0 kgf/inch, or 5.0 to 6.0 kgf/inch.

### Substrate Layer

The decorative film according to the present invention includes a substrate layer. The substrate layer acts as a support for the decorative film.

There is no particular limitation on the type of material constituting the substrate layer, but commonly used materials for substrate layers in decorative films, such as for walls, floor tiles, and wallpaper, may be used. The substrate layer may be composed of a resin containing polyvinyl chloride (PVC), polyethylene terephthalate (PET), or a mixture thereof, or it may be made of paper, woody substrates, inorganic substrates such as ceramics, and these materials may be used alone or in combinations of two or more types. The substrate layer is generally in the form of a board, but may have various shapes depending on the intended use of the decorative film, and its thickness and other properties may be appropriately selected according to the purpose. For example, when the substrate layer is composed of a resin including PVC, PET, or a mixture thereof, the processability of the decorative film may be further improved.

The resin constituting the substrate layer may further include thermoplastic resins used in the relevant technical field in addition to PVC and PET. Examples of the thermoplastic resin include polyethylene terephthalate glycol resin (PETG resin), nylon, polybutylene terephthalate resin (PBT resin), acrylonitrile-butadiene-styrene resin (ABS resin), acrylonitrile-styrene-acrylic ester resin, acrylic resin, polyolefin-based resin, and polycarbonate resin, which may be used alone or in combinations of two or more types.

### Print Layer

The decorative film according to the present invention includes a print layer on the substrate layer. The print layer is formed by digital printing using a UV ink composition.

The print layer may be formed by a digital printing method. The method of forming the digital print layer is not particularly limited, and known digital printing methods may be applied. Digital printing is a known printing method that uses an electrically controlled ink ejection system as a non-contact printing method. It is advantageous for small to large-volume production of various products and offers excellent design freedom and print quality. When applying the digital printing method, full-width designs that cannot be achieved by gravure printing can be implemented. Unlike gravure printing, there is no limitation on the number of colors that can be used, enabling multi-color expression with a wide range of colors. In addition, digital printing can produce delicate gradation effects that are difficult to achieve with gravure printing and also implement 3D effects. Additionally, digital printing enables precise alignments and can maximize the realism of natural materials such as fabric and wood.

Digital printing is generally performed using water-based inks, but in the present invention, it is performed using UV inks. Water-based inks are limited in their application to media (e.g., paper and fabric) that can withstand the surface tension and drying temperature of the water-based ink. In contrast, UV inks can be printed on all media on which water-based inks cannot be used, such as PVC, PET, acrylic, glass, polycarbonate, and coroplast. For example, when using the UV ink of the present invention, direct printing on PVC is possible.

The UV ink composition includes a dispersion, an oligomer, a monomer, and an initiator.

The dispersion may be a black dispersion, cyan dispersion, magenta dispersion, yellow dispersion, or a mixture thereof, depending on the desired color. The dispersion may have an average particle size (D50) of 50 to 200 nm, and its viscosity change at room temperature over time may be less than ±30% compared to the initial value. When the average particle size (D50) of the dispersion falls outside the above range, pigment dispersion stability may deteriorate, leading to poor ink stability. The dispersion may be included in an amount of 5 to 30 wt % based on the total weight of the UV ink composition.

The oligomer may be a polyester oligomer, urethane oligomer, epoxy oligomer, acrylic oligomer, etc. They may be used alone or in combinations of two or more types. The oligomer may have a functionality of 1 to 6 and a weight average molecular weight of 100 to 10,000 g/mol. When the functionality of the oligomer exceeds the above range, the hardness of the ink printing surface increases, resulting in reduced flexibility and cracking. In addition, when the molecular weight of the oligomer exceeds the above range, ink output stability during inkjet printing may decrease. The oligomer may be included in an amount of 1 to 30 wt % based on the total weight of the UV ink composition.

The monomer adjusts the viscosity of the UV ink composition to facilitate easier coating. The monomer may be an acrylate monomer having a molecular weight of 100 to 1,000 g/mol and a glass transition temperature of −100 to 150° C. When the molecular weight of the monomer is below the above range, under-curing of the UV ink may occur. When the molecular weight exceeds the above range, over-curing may occur, causing the coating film to become harder and more susceptible to external impacts. In addition, when the glass transition temperature of the monomer exceeds the above range, adhesion with the primer may decrease, resulting in reduced peel strength.

Examples of the monomer include monofunctional monomers such as cyclic trimethylolpropane formal acrylate (CTFA), phenoxyethyl acrylate (PHEA), ethoxy ethoxy ethyl acrylate (EOEOEA), isobornyl acrylate (IBOA), and hydroxypropyl acrylate (HPA); bifunctional monomers such as hexanediol diacrylate (HDDA), diethylene glycol diacrylate (DEGDA), tripropylene glycol diacrylate (TPGDA), dipropylene glycol diacrylate (DPGDA), triethylene glycol diacrylate (TEGDA), neopentyl glycol diacrylate (NPGDA), and polyethylene glycol diacrylate (PEGDA); and multifunctional monomers such as trimethylolpropane triacrylate (TMPTA), pentaerythritol triacrylate (PETA), and dipentaerythritol hexaacrylate (DPHA). They may be used alone or in combinations of two or more types. The monomer may be included in an amount of 10 to 80 wt % based on the total weight of the UV ink composition.

Examples of the initiator include trioxanthine, monoacylphosphine, phenyl acylphosphine, α-aminoketone, α-hydroxy ketone, etc. They may be used alone or in combinations of two or more types. The initiator may be included in an amount of 0.1 to 15 wt % based on the total weight of the UV ink composition.

### First Primer Layer

The decorative film according to the present invention includes a first primer layer on the print layer. The first primer layer serves to improve adhesion between the print layer and the transparent layer, maintain the smoothness of the base fabric, ensure uniform color in the print, and increase elongation to enhance workability.

The first primer layer is formed of a first primer composition. The first primer composition may be a solvent-based primer composition or a UV-curable primer composition.

As a solvent-based primer composition, the first primer composition may be a polyurethane primer composition or a polyester primer composition.

For example, the first primer composition may be a polyurethane primer composition including 8 to 40 wt % of polyurethane resin, 0.1 to 6 wt % of curing agent, and 55 to 90 wt % of solvent.

The polyurethane resin allows the print layer to adhere more strongly to the transparent layer. The polyurethane resin may be any known polyurethane resin without particular limitation. For example, a reaction product of a polyol and an isocyanate may be used. The polyol may be a polyester polyol, a polyether polyol, or a polycarbonate polyol, preferably a polyester polyol, but not limited thereto.

The weight average molecular weight of the polyurethane resin may be 5,000 to 100,000 g/mol, and the glass transition temperature may be −30 to 60° C. When the weight average molecular weight of the polyurethane resin is below the above range, the interlayer adhesion with the transparent layer may decrease, and when the weight average molecular weight exceeds the above range, the viscosity of the coating solution may increase, causing an uneven coating surface after high-speed gravure roll coating. When the glass transition temperature of the polyurethane resin is below the above range, the solvent resistance may decrease, causing swelling by the UV ink and resulting in surface peeling, and when the glass transition temperature exceeds the above range, the resin layer becomes hard, reducing adhesion with the transparent layer.

Examples of the curing agent include hexamethylene diisocyanate trimer (HDI trimer), isophorone diisocyanate (IPDI), toluene diisocyanate (TDI), diphenylmethane diisocyanate (MDI), xylene diisocyanate (XDI), etc.

As the solvent, fast-drying solvents, such as methyl ethyl ketone, acetone, methyl isobutyl ketone, ethyl acetate, butyl acetate, methanol, ethanol, propanol, and toluene, may be used. For example, 40 to 61 wt % of methyl ethyl ketone and 15 to 29 wt % of ethyl acetate may be included.

Alternatively, the first primer composition may be a polyester primer composition including 8 to 40 wt % of polyester resin, 0.1 to 6 wt % of curing agent, and 55 to 90 wt % of solvent.

The weight average molecular weight of the polyester resin may be 5,000 to 100,000 g/mol, and the glass transition temperature may be −25 to 65° C. When the weight average molecular weight of the polyester resin is below the above range, the interlayer adhesion with the transparent layer may decrease, and when the weight average molecular weight exceeds the above range, the viscosity of the coating solution may increase, causing an uneven coating surface after high-speed gravure roll coating. When the glass transition temperature of the polyester resin is below the above range, the solvent resistance may decrease, causing swelling by the UV ink and resulting in surface peeling, and when the glass transition temperature exceeds the above range, the resin layer becomes hard, reducing adhesion with the transparent layer.

Examples of the curing agent include hexamethylene diisocyanate trimer (HDI trimer), isophorone diisocyanate (IPDI), toluene diisocyanate (TDI), diphenylmethane diisocyanate (MDI), xylene diisocyanate (XDI), etc.

As the solvent, fast-drying solvents, such as methyl ethyl ketone, acetone, methyl isobutyl ketone, ethyl acetate, butyl acetate, methanol, ethanol, propanol, and toluene, may be used. For example, 40 to 61 wt % of methyl ethyl ketone and 15 to 29 wt % of ethyl acetate may be included.

The first primer composition may be a UV-curable primer composition. The UV-curable primer composition may include an oligomer, a monomer, and an initiator. For example, the UV-curable primer composition may include 10 to 60 wt % of oligomer, 10 to 80 wt % of monomer, and 0.1 to 15 wt % of initiator, based on the total weight of the first primer composition.

The oligomer may be a polyester oligomer, urethane oligomer, epoxy oligomer, acrylic oligomer, etc. They may be used alone or in combinations of two or more types. The oligomer may have a functionality of 2 to 6 and a molecular weight of 100 to 10,000 g/mol. When the functionality of the oligomer is below the above range, UV curing may be difficult and adhesion performance may decrease, and when it exceeds the above range, the hardness of the primer layer increases, causing the primer layer to break or crack, which may adversely affect the quality of the final product.

The monomer adjusts the viscosity of the primer composition to facilitate easier coating. The monomer may be an acrylate monomer having a molecular weight of 100 to 1,000 g/mol and a glass transition temperature of −100 to 150° C. When the molecular weight of the monomer is below the above range, problems with UV curing may occur. When the molecular weight of the monomer exceeds the above range, the hardness of the primer layer increases, causing the primer layer to break or crack. When the molecular weight falls outside the above range, the peel strength may decrease. Meanwhile, when the glass transition temperature of the monomer falls outside the above range, the peel strength may decrease.

Examples of the monomer include monofunctional monomers such as cyclic trimethylolpropane formal acrylate (CTFA), phenoxyethyl acrylate (PHEA), ethoxy ethoxy ethyl acrylate (EOEOEA), isobornyl acrylate (IBOA), and hydroxypropyl acrylate (HPA); bifunctional monomers such as hexanediol diacrylate (HDDA), diethylene glycol diacrylate (DEGDA), tripropylene glycol diacrylate (TPGDA), dipropylene glycol diacrylate (DPGDA), triethylene glycol diacrylate (TEGDA), neopentyl glycol diacrylate (NPGDA), and polyethylene glycol diacrylate (PEGDA); and multifunctional monomers such as trimethylolpropane triacrylate (TMPTA), pentaerythritol triacrylate (PETA), and dipentaerythritol hexaacrylate (DPHA). They may be used alone or in combinations of two or more types.

Examples of the initiator include trioxanthine, monoacylphosphine, phenyl acylphosphine, α-aminoketone, α-hydroxy ketone, etc. They may be used alone or in combinations of two or more types.

The first primer layer may have a thickness of 2 to 5 μm. When the thickness of the first primer layer is below the above range, adhesion and heat resistance may decrease, and when it exceeds the above range, workability may decrease due to issues such as poor drying.

### Transparent Layer

The decorative film according to the present invention includes a transparent layer on the first primer layer. The transparent layer serves as a protective layer for the print layer or the first primer layer, maintaining the durability, chemical resistance, and abrasion resistance of the final product. The transparent layer may be formed of known materials such as polyvinyl chloride (PVC), but is not limited thereto. The thickness of the transparent layer is not particularly limited. For example, the thickness may be 0.05 to 1.0 mm.

### Second Primer Layer

The decorative film according to the present invention may further include a second primer layer between the substrate layer and the print layer. The second primer layer serves to improve the adhesion between the substrate layer and the print layer, ensure a uniform printed surface, enhance feeding stability of a roll base fabric to improve printing quality, and increase elongation to enhance workability.

The second primer layer is formed of a second primer composition. The second primer composition may be a solvent-based primer composition or a UV-curable primer composition.

As a solvent-based primer composition, the second primer composition may be a polyurethane primer composition or a polyester primer composition.

For example, the second primer composition may be a polyurethane primer composition including 8 to 40 wt % of polyurethane resin, 0.1 to 6 wt % of curing agent, and 55 to 90 wt % of solvent.

The polyurethane resin allows the print layer to adhere more strongly to the substrate layer. The polyurethane resin may be any known polyurethane resin without particular limitation. For example, a reaction product of a polyol and an isocyanate may be used. The polyol may be a polyester polyol, a polyether polyol, or a polycarbonate polyol, preferably a polyester polyol, but not limited thereto.

The weight average molecular weight of the polyurethane resin may be 5,000 to 100,000 g/mol, and the glass transition temperature may be −30 to 60° C. When the weight average molecular weight of the polyurethane resin is below the above range, the interlayer adhesion with the print layer may decrease, and when the weight average molecular weight exceeds the above range, the viscosity of the coating solution may increase, causing an uneven coating surface after high-speed gravure roll coating. When the glass transition temperature of the polyurethane resin is below the above range, the solvent resistance may decrease, causing swelling by the UV ink and resulting in surface peeling, and when the glass transition temperature exceeds the above range, the resin layer becomes hard, reducing adhesion with the print layer.

Examples of the curing agent include hexamethylene diisocyanate trimer (HDI trimer), isophorone diisocyanate (IPDI), toluene diisocyanate (TDI), diphenylmethane diisocyanate (MDI), xylene diisocyanate (XDI), etc.

As the solvent, fast-drying solvents, such as methyl ethyl ketone, acetone, methyl isobutyl ketone, ethyl acetate, butyl acetate, methanol, ethanol, propanol, and toluene, may be used. For example, 40 to 61 wt % of methyl ethyl ketone and 15 to 29 wt % of ethyl acetate may be included.

Alternatively, the second primer composition may be a polyester primer composition including 8 to 40 wt % of polyester resin, 0.1 to 6 wt % of curing agent, and 55 to 90 wt % of solvent.

The weight average molecular weight of the polyester resin may be 5,000 to 100,000 g/mol, and the glass transition temperature may be −25 to 65° C. When the weight average molecular weight of the polyester resin is below the above range, the interlayer adhesion with the print layer may decrease, and when the weight average molecular weight exceeds the above range, the viscosity of the coating solution may increase, causing an uneven coating surface after high-speed gravure roll coating. When the glass transition temperature of the polyester resin is below the above range, the solvent resistance may decrease, causing swelling by the UV ink and resulting in surface peeling, and when the glass transition temperature exceeds the above range, the resin layer becomes hard, reducing adhesion with the print layer.

Examples of the curing agent include hexamethylene diisocyanate trimer (HDI trimer), isophorone diisocyanate (IPDI), toluene diisocyanate (TDI), diphenylmethane diisocyanate (MDI), xylene diisocyanate (XDI), etc.

As the solvent, fast-drying solvents, such as methyl ethyl ketone, acetone, methyl isobutyl ketone, ethyl acetate, butyl acetate, methanol, ethanol, propanol, and toluene, may be used. For example, 40 to 61 wt % of methyl ethyl ketone and 15 to 29 wt % of ethyl acetate may be included.

The second primer composition may be a UV-curable primer composition. The UV-curable primer composition may include an oligomer, a monomer, and an initiator. For example, the UV-curable primer composition may include 10 to 60 wt % of oligomer, 10 to 80 wt % of monomer, and 0.1 to 15 wt % of initiator, based on the total weight of the second primer composition.

The oligomer may be a polyester oligomer, urethane oligomer, epoxy oligomer, acrylic oligomer, etc. They may be used alone or in combinations of two or more types. The oligomer may have a functionality of 2 to 6 and a molecular weight of 100 to 10,000 g/mol. When the functionality of the oligomer is below the above range, UV curing may be difficult and adhesion performance may decrease, and when it exceeds the above range, the hardness of the primer layer increases, causing the primer layer to break or crack, which may adversely affect the quality of the final product.

The monomer adjusts the viscosity of the primer composition to facilitate easier coating. The monomer may be an acrylate monomer having a molecular weight of 100 to 1,000 g/mol and a glass transition temperature of −100 to 150° C. When the molecular weight of the monomer is below the above range, problems with UV curing may occur. When the molecular weight of the monomer exceeds the above range, the hardness of the primer layer increases, causing the primer layer to break or crack. When the molecular weight falls outside the above range, the peel strength may decrease. Meanwhile, when the glass transition temperature of the monomer falls outside the above range, the peel strength may decrease.

Examples of the monomer include monofunctional monomers such as cyclic trimethylolpropane formal acrylate (CTFA), phenoxyethyl acrylate (PHEA), ethoxy ethoxy ethyl acrylate (EOEOEA), isobornyl acrylate (IBOA), and hydroxypropyl acrylate (HPA); bifunctional monomers such as hexanediol diacrylate (HDDA), diethylene glycol diacrylate (DEGDA), tripropylene glycol diacrylate (TPGDA), dipropylene glycol diacrylate (DPGDA), triethylene glycol diacrylate (TEGDA), neopentyl glycol diacrylate (NPGDA), and polyethylene glycol diacrylate (PEGDA); and multifunctional monomers such as trimethylolpropane triacrylate (TMPTA), pentaerythritol triacrylate (PETA), and dipentaerythritol hexaacrylate (DPHA). They may be used alone or in combinations of two or more types.

Examples of the initiator include trioxanthine, monoacylphosphine, phenyl acylphosphine, α-aminoketone, α-hydroxy ketone, etc. They may be used alone or in combinations of two or more types.

The second primer layer may have a thickness of 1 to 3 μm. When the thickness of the second primer layer is below the above range, adhesion and heat resistance may decrease, and when the thickness exceeds the above range, workability may decrease due to issues such as poor drying.

### Modes of the Invention

Hereinafter, the present invention will be described in more detail through examples. However, the following examples are provided only to facilitate understanding of the present invention and do not intend to limit the scope of the present invention to these examples.

### Preparation Example 1: Preparation of Primer Compositions

Each primer composition was prepared according to Table 1 below.

TABLE 1

| Component | PUD | PE | Curing | | |
|---|---|---|---|---|---|
| (g) | resin | resin | agent | Solvent | Total |
| A-1 | 30 | | 2 | 68 | 100 |
| A-2 | 10 | | 1 | 89 | 100 |
| A-3 | | 30 | 2 | 68 | 100 |
| A-4 | | 10 | 1 | 89 | 100 |

PUD resin: Modified polyurethane resin (weight average molecular weight of 10,000 g/mol, glass transition temperature of 51° C., hydroxyl value of 70 mg KOH/g)
PE resin: Unsaturated polyester resin (weight average molecular weight of 51,000 g/mol, glass transition temperature of 62° C., hydroxyl value of 80 mg KOH/g)
Curing agent: Hexamethylene diisocyanate trimer
Solvent: Methyl ethyl ketone

### Preparation Example 2: Preparation of UV Ink Compositions

Each ink composition was prepared according to Table 2 below.

TABLE 2

Component (g)

| | | B-1 | B-2 |
|---|---|---|---|
| Dispersion | | 20 | 20 |
| Oligomer | | 8 | 8 |
| Monomer | HDDA | 10 | 20 |
| | THFA | 20 | 25 |
| | PHEA | 35 | |
| | EOEOEA | | 35 |
| Initiator | TPO | 5 | 4 |
| | Irgacure 819 | 2 | 3 |

| | | |
|---|---|---|
| Total | 100 | 115 |

Dispersion: 15 wt % pigment (Color Black S160), 7 wt % dispersant (BYK-9152), 78 wt % solvent (Ethoxyethoxy ethyl acrylate (EOEOEA))
Oligomer: Bifunctional aliphatic urethane acrylate (weight average molecular weight of 1,000 g/mol, viscosity (25° C.) of 11,430 cps)
HDDA: 1,6-Hexanediol diacrylate
THFA: Tetrahydrofurfuryl acrylate
PHEA: 2-Phenoxyethyl acrylate
EOEOEA: 2-(2-Ethoxyethoxy) ethyl acrylate
TPO: 2,4,6-Trimethylbenzoyldiphenyl phosphine oxide

### Experimental Examples 1-22

A second primer composition was applied to the upper surface of a substrate sheet to form a second primer layer (with a thickness of 2-3 μm), followed by the formation of a print layer by digital printing using a UV ink composition. Subsequently, a first primer composition was applied to form a first primer layer (with a thickness of 2-3 μm), and a transparent layer was laminated on top. Using this method, decorative films with a structure consisting of a substrate layer, second primer layer, print layer, first primer layer, and transparent layer laminated in this order, as shown in Tables 3 to 5, were manufactured for each experimental example.

TABLE 3

| | | Experimental Example | | | | | | | |
|---|---|---|---|---|---|---|---|---|---|
| Classification | | 1 | 2 | 3 | 4 | 5 | 6 | 7 | 8 |
| Substrate | PVC | O | O | O | O | O | O | O | O |
| layer | PET | | | | | | | | |
| Second | A-1 | | | | | O | | | |
| primer | A-2 | | | | | | O | | |
| layer | A-3 | | | | | | | O | |
| | A-4 | | | | | | | | O |
| Print | B-1 | O | O | O | O | O | O | O | O |
| layer | B-2 | | | | | | | | |
| | B-3 | | | | | | | | |
| | B-4 | | | | | | | | |
| First | A-1 | O | | | | O | O | O | O |
| primer | A-2 | | O | | | | | | |
| layer | A-3 | | | O | | | | | |
| | A-4 | | | | O | | | | |

| | | | | | | | | |
|---|---|---|---|---|---|---|---|---|
| Transparent | O | O | O | O | O | O | O | O |
| layer | | | | | | | | |

TABLE 4

| | | Experimental Example | | | | | | | |
|---|---|---|---|---|---|---|---|---|---|
| Classification | | 9 | 10 | 11 | 12 | 13 | 14 | 15 | 16 |
| Substrate | PVC | O | O | O | O | O | O | O | O |
| layer | PET | | | | | | | | |
| Second | A-1 | | | | | O | | | |
| primer | A-2 | | | | | | O | | |
| layer | A-3 | | | | | | | O | |
| | A-4 | | | | | | | | O |
| Print | B-1 | | | | | | | | |
| layer | B-2 | O | O | O | O | O | O | O | O |
| | B-3 | | | | | | | | |
| | B-4 | | | | | | | | |
| First | A-1 | O | | | | O | O | O | O |
| primer | A-2 | | O | | | | | | |
| layer | A-3 | | | O | | | | | |
| | A-4 | | | | O | | | | |

| | | | | | | | | |
|---|---|---|---|---|---|---|---|---|
| Transparent | O | O | O | O | O | O | O | O |
| layer | | | | | | | | |

TABLE 5

| | | Experimental Example | | | | | |
|---|---|---|---|---|---|---|---|
| Classification | | 17 | 18 | 19 | 20 | 21 | 22 |
| Substrate | PVC | | O | O | O | O | O |
| layer | PET | O | | | | | |
| | A-1 | O | | | | O | O |
| Second | A-2 | | | | | | |
| primer | A-3 | | | | | | |
| layer | A-4 | | | | | | |
| Print | B-1 | O | O | | | | |
| layer | B-2 | | | | | | |
| | B-3 | | | O | | O | |
| | B-4 | | | | O | | O |
| First | A-1 | O | | | | | |
| primer | A-2 | | | | | | |
| layer | A-3 | | | | | | |
| | A-4 | | | | | | |

| | | | | | | |
|---|---|---|---|---|---|---|
| Transparent | O | O | O | O | O | O |
| layer | | | | | | |

A-1: Primer composition (A-1) of Preparation Example 1
A-2: Primer composition (A-2) of Preparation Example 1
A-3: Primer composition (A-3) of Preparation Example 1
A-4: Primer composition (A-4) of Preparation Example 1
B-1: UV ink composition (B-1) of Preparation Example 2
B-2: UV ink composition (B-2) of Preparation Example 2
B-3: Water-based latex ink (LX100, Mimaki)
B-4: Oil-based ink (SS21, Mimaki)

### [Property Evaluation]

The properties of the decorative films manufactured in each experimental example were measured by the following method, and the results are shown in Tables 6 to 8.

### Peel Strength

Using a universal testing machine (manufacturer: SALT Co., Ltd., model: ST-1003), the 180° peel strength between the substrate layer and the print layer and the 180° peel strength between the print layer and the transparent layer of each decorative film were measured.

TABLE 6

| | Experimental Example | | | | | | | |
|---|---|---|---|---|---|---|---|---|
| Classification | 1 | 2 | 3 | 4 | 5 | 6 | 7 | 8 |
| Peel strength | 3.3 | 3.4 | 3.4 | 3.4 | 4.6 | 4.5 | 4.8 | 4.9 |
| between the | | | | | | | | |
| substrate and print | | | | | | | | |
| layers (kgf/inch) | | | | | | | | |
| Peel strength | 5.1 | 5 | 5.4 | 5.6 | 5.2 | 5.1 | 5.4 | 5.5 |
| between the print | | | | | | | | |
| and transparent | | | | | | | | |
| layers (kgf/inch) | | | | | | | | |

TABLE 7

| | Experimental Example | | | | | | | |
|---|---|---|---|---|---|---|---|---|
| Classification | 9 | 10 | 11 | 12 | 13 | 14 | 15 | 16 |
| Peel strength | 3 | 3.1 | 3.1 | 3 | 4.5 | 4.6 | 4.9 | 4.8 |
| between the | | | | | | | | |
| substrate and print | | | | | | | | |
| layers (kgf/inch) | | | | | | | | |
| Peel strength | 4.9 | 4.8 | 5.1 | 5 | 4.7 | 4.8 | 4.7 | 4.9 |
| between the print | | | | | | | | |
| and transparent | | | | | | | | |
| layers (kgf/inch) | | | | | | | | |

TABLE 8

| | Experimental Example | | | | | |
|---|---|---|---|---|---|---|
| Classification | 17 | 18 | 19 | 20 | 21 | 22 |
| Peel strength | 4.2 | 3.2 | 3.3 | 3.1 | 4.5 | 4.8 |
| between the substrate | | | | | | |
| and print layers | | | | | | |
| (kgf/inch) | | | | | | |
| Peel strength | 5.2 | 0.8 | 0.7 | 1 | 0.9 | 0.8 |
| between the print | | | | | | |
| and transparent | | | | | | |
| layers (kgf/inch) | | | | | | |

As shown in Tables 3 to 8, decorative films of Experimental Examples 1 to 17, which include a substrate layer, a print layer formed by digital printing using a UV ink composition, a first primer layer, and a transparent layer, exhibited peel strengths of 3.0 kgf/inch or more between the substrate and print layers and between the print and transparent layers. In particular, decorative films that include a substrate layer, a second primer layer, a print layer, a first primer layer, and a transparent layer (Experimental Examples 5 to 8 and 13 to 17) demonstrated superior performance, with peel strengths of 4.0 kgf/inch or more between the substrate and print layers and between the print and transparent layers.

On the other hand, the decorative film of Experimental Example 18, which does not include a first primer layer and a second primer layer, and decorative films of Experimental Examples 19 to 22, in which the print layer was formed using water-based latex ink (B-3) or oil-based ink (B-4) instead of UV ink and which do not include a first primer layer, exhibited peel strengths of less than 3.0 kgf/inch between the substrate and print layers and between the print and transparent layers.

### INDUSTRIAL APPLICABILITY

The present invention provides a decorative film that has a high degree of design freedom and excellent formability.

1. A decorative film comprising a substrate layer, a print layer formed by digital printing, a first primer layer, and a transparent layer, which are sequentially laminated,
wherein the print layer is formed of a UV ink composition,
the peel strength between the substrate layer and the print layer is 3.0 kgf/inch or more, and
the peel strength between the print layer and the transparent layer is 3.0 kgf/inch or more.

2. The decorative film of claim 1, further comprising a second primer layer between the substrate layer and the print layer.

3. The decorative film of claim 2, wherein the second primer layer is formed of a second primer composition,
the second primer composition is a solvent-based primer composition or a UV-curable primer composition,
the solvent-based primer composition is a polyurethane primer composition or a polyester primer composition,
the polyurethane primer composition comprises 8 to 40 wt % of polyurethane resin, 0.1 to 6 wt % of curing agent, and 55 to 90 wt % of solvent, and
the polyester primer composition comprises 8 to 40 wt % of polyester resin, 0.1 to 6 wt % of curing agent, and 55 to 90 wt % of solvent.

4. The decorative film of claim 1, wherein the first primer layer is formed of a first primer composition,
the first primer composition is a solvent-based primer composition or a UV-curable primer composition,
the solvent-based primer composition is a polyurethane primer composition or a polyester primer composition,
the polyurethane primer composition comprises 8 to 40 wt % of polyurethane resin, 0.1 to 6 wt % of curing agent, and 55 to 90 wt % of solvent, and
the polyester primer composition comprises 8 to 40 wt % of polyester resin, 0.1 to 6 wt % of curing agent, and 55 to 90 wt % of solvent.

5. The decorative film of claim 3, wherein the polyurethane resin has a weight average molecular weight of 5,000 to 100,000 g/mol and a glass transition temperature of −30 to 60° C., and
the polyester resin has a weight average molecular weight of 5,000 to 100,000 g/mol and a glass transition temperature of −25 to 65° C.

6. The decorative film of claim 1, wherein the UV ink composition comprises a dispersion, an oligomer, a monomer, and an initiator,
the dispersion has an average particle size (D50) of 50 to 200 nm and a viscosity change at room temperature over time of less than ±30% relative to the initial value,
the oligomer has a functionality of 1 to 5 and a weight average molecular weight of 100 to 10,000 g/mol, and
the monomer comprises an acrylate monomer having a molecular weight of 100 to 1,000 g/mol and a glass transition temperature of −100 to 150° C.
